(19) United States
(12) Patent Application Publication
(10) Pub. No.: US 2009/0019724 A1
(43) Pub. Date: Jan. 22, 2009

(54) APPARATUS FOR LOADING AND UNLOADING A TRAY OF A FREEZE DRYING PLANT AND METHOD THEREOF

(75) Inventors: Alexander Wagner, Lohra (DE); Ralf Battenberg, Fronhausen (DE)

Correspondence Address: HANLEY, FLIGHT & ZIMMERMAN, LLC, 150 S. WACKER DRIVE, SUITE 2100, CHICAGO, IL, 60606, US

(73) Assignee: ACCURRO GMBH, Fronhausen (DE)

(21) Appl. No.: 12/175,959

(22) Filed: Jul. 18, 2008

(30) Foreign Application Priority Data
Jul. 21, 2007 (DE) 102007034084.4

(51) Int. Cl. F26B 13/10; F26B 5/06

(52) U.S. Cl. 34/573; 34/284

(57) ABSTRACT

The object of the disclosure is an apparatus for loading and unloading a tray (16) of a freeze drying plant (10) with a number of vials (16), with a transfer table (20) provided upstream of the freeze drying plant (10) for receiving temporarily said vials (18), and with a pusher apparatus for displacing said vials (18) from said transfer table (20) to said tray (16) or from said tray (16) to said transfer table (20), said pusher apparatus including a right-handed and a left-handed transport carriage.(30). To provide an apparatus for loading and unloading a tray of a freeze drying plant that allows for proper unloading of the tray even if the distance between neighbouring trays of the freeze drying plant is reduced to a minimum is achieved in that the pusher apparatus further includes a loading element (38) and an unloading pusher (50), said loading element (38) being disposed outside of the freeze drying plant (10) whilst the unloading pusher (50) is arranged inside the freeze drying plant (10).

### CROSS-REFERENCE TO RELATED APPLICATIONS

This application claims Priority from German Application No. DE 10 2007 034 084.4 filed on 21 Jul. 2007.

### FIELD OF THE DISCLOSURE

The present disclosure relates to an apparatus for loading and unloading a tray of a freeze drying plant as set forth in the preamble of the claims 1, as well as to a method for a respective one thereof, according to the preamble of the claims 11 and 12.

The material to be dried in a freeze drying plant is filled into small bottles which are referred to as vials and transported with the help of said vials. Lids are provided on these vials and are closed upon completion of the freeze drying process.

The vials, which are filled with the material to be freeze dried and whose lid is still open, are brought onto a transfer table from where they are conveyed to a tray in the interior of the freeze drying plant by means of a pusher apparatus. In the freeze drying plant there are provided a plurality of trays, which, for loading the freeze drying plant, are taken from a stack, raised to the height of the transfer table and loaded with the vials. Once the tray is filled, said tray is moved upward together with the already previously filled trays and the next tray is taken from the stack and brought to the level of the transfer table, and so on. Upon completion of the freeze drying process, the trays are brought together in such a manner that the tray located above the vials comes to rest on the lids of the vials which it pushes into the vials so that the vials are henceforth closed. Then, the trays are again pulled apart for the tray located on the height of the transfer plate to be unloaded. As soon as this tray has been unloaded, it is brought to the bottom of the freeze drying plant where it is stacked whilst the next tray is moved to the level of the transfer table in order to be unloaded, and so on.

### BACKGROUND OF RELATED ART

A device for loading and unloading a tray of a freeze drying plant is known from EP 1 619 459 A1, the pusher apparatus thereof including a bar that is adapted for upward and downward pivotal movement and that is retained on a carriage guided on the right and on the left side of the transfer table and on the tray. The carriages are guided on special rails which are attached to the right and left edge of the transfer plate and of the tray. The rails are configured to be a web protruding upwards at right angles and concurrently forming a lateral limitation for the vials located on the transfer table or on the tray.

To load the tray with a number of vials, said vials are at first placed onto the transfer table. As soon as there are enough vials on the table, the bar retained on the carriages is brought to the foremost vials, a flexible metal tape being attached to a respective one of the right and left carriages and being actuated through a drive. Then, the bar is moved further in the direction of the tray, thus pushing the vials in front of it. The rails, which act as a side limitation, hereby ensure that no vials will fall down from the transfer table or from the tray. As soon as the foremost vials have been placed onto the tray, the metal tapes pull the carriages, and as a result thereof the bar, back into the initial position before the bar is pivoted away upward through a pivoting mechanism mounted to the carriage for the next vials to be passed underneath the bar and be placed onto the transfer plate. At the same time, the now filled tray is moved upward in the freeze drying plant and the next, empty tray is provided. If enough vials are on the transfer table, this process is repeated and the pusher device pushes the next group of vials onto the next tray.

For unloading, the bar is again travelled upward through the pivoting mechanism and, through the flexible tapes, is brought together with the carriage as far as the rear edge of the tray where the bar is lowered again. Then, the tapes are pulled tight again, thus pulling the carriage and the bar together with the vials from the tray onto the transfer table from where the vials are then evacuated.

Upon pushing the vials from the transfer plate onto the tray, it may happen that the vials, which had originally been placed correctly in discrete rows, get disarranged, some vials also being brought as far as the rail confining them laterally. If the number of vials continues to be pushed onto the tray, the outer vials are caused to touch the rail, the vials getting even more disarranged due to the occurring friction. Some vials may also tumble.

Upon completion of the freeze drying process, the pusher apparatus is moved as far as the rear border of the tray by means of the carriages guided on the rails. Often, the carriage needs to push vials located close to the rail slightly aside in order to arrive at the rear end of the tray. Hereby, the vials are even further disarranged and discrete vials can tumble.

During unloading, the vials are now at first pushed together in analogous fashion in the opposite direction and are moved from the tray onto the transfer table. Again, a friction occurs between the outer vials and the rail confining the sides so that the vials get even more disarranged and that a vial may tumble.

Moreover, it happens that some vials get stuck on the underside of the tray located above after the freeze drying process. If now the pusher device is introduced with the bar into the freeze drying plant, the bar hits the vials sticking on the underside of the next tray; as they fall down, these vials can tip over.

Food or drugs are often processed in freeze drying plants. As a result, the hygiene requirements are very demanding. As a result, tipped over vials are not allowed to be processed further and constitute scrap material.

### SUMMARY

In view thereof, it is the object of the present disclosure to provide an apparatus and a method of the type mentioned herein above that allow for proper unloading of the tray even if the distance between neighbouring trays of the freeze drying system is reduced to a minimum. Another object of the disclosure is to return the vials securely onto the tray.

As a technical solution to this object, an apparatus for loading and unloading a tray of a freeze drying plant having the features of claim 1 and a method of loading and unloading a tray of a freeze drying plant having the features of claim 11 and claim 12 respectively are proposed. Advantageous developed implementations of this apparatus and of these methods will become apparent from the respective dependent claims.

An apparatus for loading and unloading a tray of a freeze drying plant configured in accordance with this technical teaching and a method for loading and unloading a tray of a freeze drying plant configured in accordance with this technical teaching have the advantage that, by physically separating loading pusher and unloading pusher a separate load pusher is available for each case of application. As a result, the unloading pusher can be disposed within the freeze drying plants whilst the loading pusher is disposed outside of the freeze drying plant. This offers the advantage that the unloading pusher for unloading the vials needs not be led past the great number of vials, which is cumbersome; it already is available behind the vials. As a result, vials adhering to the upper tray can no longer be knocked over while the pusher apparatus is being introduced into the freeze drying plant and behind the already closed vials.

Another advantage is that the free space between the vials and the next tray located above can be reduced to a minimum since the unloading pusher needs no longer be led through this free space. As a result, either larger sized vials can be placed onto the tray or additional trays can be provided in the freeze drying plant. In any case however, the capacity of the freeze drying plant is thus increased.

It has thereby been found advantageous to mount the unloading pusher on a side of the chamber opposite the openings of the freeze drying plant since the unloading pusher is already disposed behind the vials and needs no longer be led past the vials as a result thereof.

In a preferred embodiment, the unloading pusher is retained on a retaining mechanism that is mounted to a rear wall of the freeze drying plant. This retaining mechanism is suited to place the unloading pusher onto the transport carriage, in particular onto the pusher chain or the rod, and to remove the unloading pusher from the transport carriage again. As a result, the pusher apparatus can be readily complemented without the unloading pusher having to be led past the vials.

In another preferred embodiment, the transport carriage is displaceable transverse to its travel direction. This has the advantage that the transport carriage can be moved at a distance from the vials during empty run for the position of the vials not to be inadvertently changed.

In a preferred developed implementation, the unloading pusher has one long hole at either of its two ends. This offers the advantage that the unloading pusher can be placed readily onto the transport carriage and that the transport carriage can be displaced transverse to the travel direction in spite of the unloading pusher placed thereon.

This applies in analogous fashion to the loading pusher.

For loading the tray, the loading pusher is placed by means of the shelf onto the transport carriages guided on the right and on the left border of the transfer table before the transport carriages are caused to move together with the loading pusher and the vials onto the tray. The advantage thereof is that the transport carriages and the vials are caused to move at the same speed so that no friction occurs between the transport carriages and the vials located on the border. As a result, discrete vials are prevented from inadvertently tumbling.

To unload the tray, the right and the left transport carriage are completely retracted into the freeze drying plant for one part of the transport carriage to extend as far as behind the vials. Then, the unloading pusher is placed onto this part of the transport carriage before said transport carriages are pulled out of the freeze drying plant, together with the unloading pusher and the vials. Here again, the transport carriages are caused to move at the same speed as the vials so that no relative velocity and, as a result thereof, no friction occurs between the vials and the transport carriage so that no vials can tumble.

Another advantage of this method is that the unloading pusher needs not be conducted between the vials and the next higher tray, which is cumbersome since the unloading pusher is already behind the trays anyway. As a result, larger sized vials can be utilized or the distance between the vials and the next higher tray can be reduced, which in both cases leads to increased capacity of the freeze drying plant.

Also, discrete vials are prevented from being knocked over since the vials sticking on the underside of the tray are no longer detached by the unloading pusher but are instead detached when the entire number of vials is being pulled out. Since the distance between the vials and the next tray is less large, the neighbouring vials can serve as a kind of guidance and can thus return the vial falling down to its original position without the vial tipping over.

To check the freeze drying process and for quality control, it is desirable to know, even after the vials have been transported away for further processing, at which position inside the freeze drying plant the various vials stood. With the present apparatus, it is possible to reconstruct the position of every single vial since the sequence and order of the vials is not changed during loading or unloading. Accordingly, it is sufficient for quality control to check the vials that stood on critical places on the tray in order to conclude the quality of the entire freeze drying process. This reduces the control expense. Also, when a plurality of vials are checked, it can be found out whether the freeze drying process itself can be improved.

Further advantages of the apparatus of the disclosure for loading and unloading a tray of a freeze drying plant and of the methods of the disclosure for loading and unloading a tray of a freeze drying plant will become apparent in the appended drawings and in the following description of embodiments thereof. Likewise, the disclosure lies in each and every novel feature or combination of features mentioned above or described herein after. The embodiments discussed herein are merely exemplary in nature and are not intended to limit the scope of the disclosure in any manner.

### BRIEF DESCRIPTION OF THE DRAWINGS

In said drawings:

FIG. 1a shows in a schematic illustration a sectional side view of a first embodiment of an apparatus of the disclosure and of a freeze drying plant at a first time period, taken along line Ia-Ia in FIG. 1b;

FIG. 1b is a sectional top view of the apparatus and the freeze dryer plant shown in FIG. 1a, taken along line Ib-Ib in FIG. 1a;

FIG. 1c is a sectional front view of the apparatus and the freeze drying plant as shown in FIG. 1a, taken along line Ic-Ic in FIG. 1a;

FIG. 1d is an enlarged detail of the apparatus of the disclosure, taken along line Id in FIG. 1c;

FIG. 1e is an enlarged detail of the apparatus of the disclosure, taken along line Ie in FIG. 1b;

FIG. 1f is a sectional side view of the enlarged detail as shown in FIG. 1e, taken along line If-If in FIG. 1e;

FIG. 2a is a sectional side view of the apparatus and of the freeze drying plant as shown in FIG. 1a, at a second time period, taken along line IIa-IIa in FIG. 2b;

FIG. 2b is a sectional top view of the apparatus and of the freeze drying plant as shown in FIG. 2a, taken along line IIb-IIb in FIG. 2a;

FIG. 2c is an enlarged detail of the apparatus of the disclosure, taken along line IIc in FIG. 2b;

FIG. 3a is a sectional top view of the apparatus and of the freeze drying plant as shown in FIG. 1a, at a third time period;

FIG. 3b is an enlarged detail of the apparatus of the disclosure taken along line IIIb in FIG. 3a;

FIG. 4 is a sectional top view of the apparatus and of the freeze drying plant as shown in FIG. 1a, at a fourth time period;

FIG. 5 is a sectional side view of the apparatus and of the freeze drying plant as shown in FIG. 1a, at a fifth time period;

FIG. 6 is a sectional side view of the apparatus and of the freeze drying plant as shown in FIG. 1a, at a sixth time period;

FIG. 7 is a sectional side view of the apparatus and of the freeze drying plant as shown in FIG. 1a, at a seventh time period;

FIG. 8a is a sectional side view of the apparatus and of the freeze drying plant as shown in FIG. 1a, at an eighth time period;

FIG. 8b is an enlarged detail view of the apparatus of the disclosure taken along line VIIIb in FIG. 8a;

FIG. 9 is a sectional side view of the apparatus and of the freeze drying plant as shown in FIG. 1a, at a ninth time period;

FIG. 10 is a sectional side view of the apparatus and of the freeze drying plant as shown in FIG. 1a, at a tenth time period;

FIG. 11 is a sectional side view of the apparatus and of the freeze drying plant as shown in FIG. 1a, at a eleventh time period;

FIG. 12a is a schematic sectional side view of a second embodiment of an apparatus of the disclosure and of a freeze drying plant at a first time period;

FIG. 12b shows the apparatus as shown in FIG. 12a at a second time period;

FIG. 12c shows the apparatus as shown in FIG. 12a at a second time period;

FIG. 13a is a schematic sectional top view of a third embodiment of an apparatus of the disclosure and of a freeze drying plant at a first time period, taken along line XIIIa-XIIIa in FIG. 13c;

FIG. 13b shows an enlarged detail of the apparatus of the disclosure as shown in FIGS. 13a, taken along line XIIIb in FIG. 13a;

FIG. 13c is a sectional front view of the apparatus and the freeze drying plant shown in FIG. 13a, taken along line XIIIb-XIIIb in FIG. 13a;

FIG. 13d is a sectional view of an enlarged detail of the disclosure as shown in FIG. 13c, taken along line XIIId-XIIId in FIG. 13c, at a first time period;

FIG. 13e shows the enlarged detail of FIG. 13d, at a second time period;

FIG. 14a is a schematic sectional side view of a fourth embodiment of an apparatus of the disclosure and of a freeze drying plant at a first time period, taken along XIVa-XIVa in FIG. 14b;

FIG. 14b is a sectional top view of the apparatus and of the freeze drying plant as shown in FIG. 14a, taken along line Linie XIVb-XIVb in FIG. 14a;

FIG. 14c is a sectional front view of the apparatus and of the freeze drying plant shown in FIG. 14a, taken along line XIVc-XIVc in FIG. 14a;

FIG. 14d shows an enlarged detail of the apparatus of the disclosure as shown in FIG. 14a, taken along line XIVd in FIG. 14c;

FIG. 14e shows an enlarged detail of the apparatus of the disclosure as shown in FIG. 14a, taken along line XIVe in FIG. 14c;

FIG. 14f is a sectional side view of an enlarged detail as shown in FIG. 14e, taken along line XIVf-XIVf in FIG. 14e.

### DETAILED DESCRIPTION

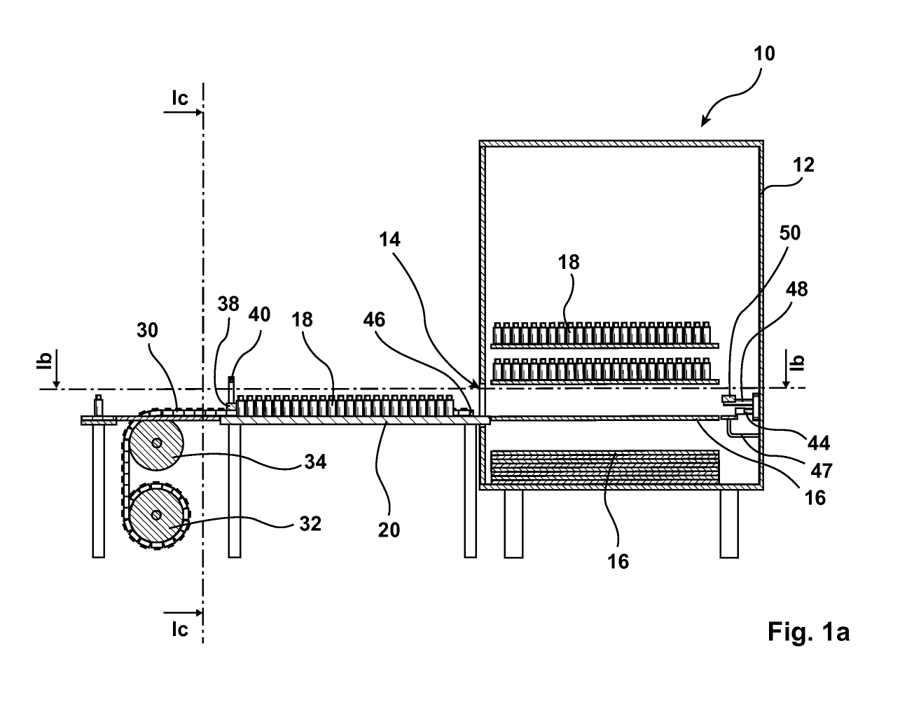

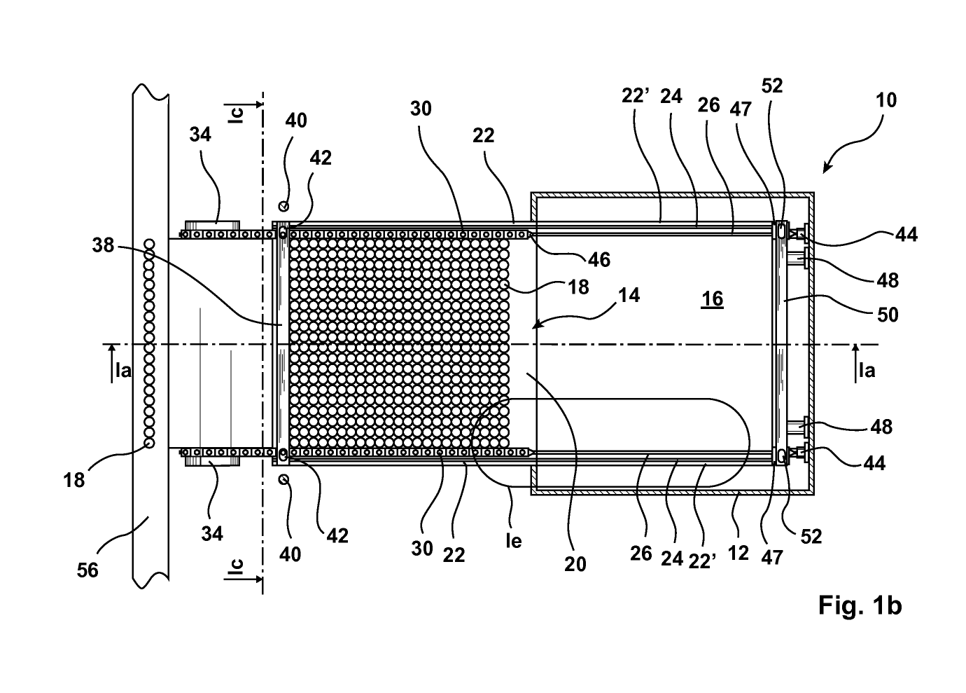

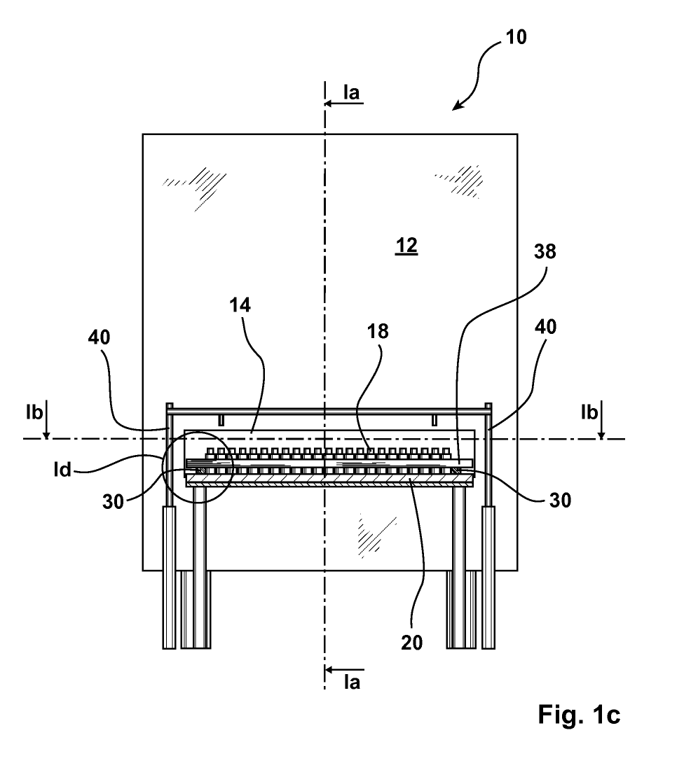

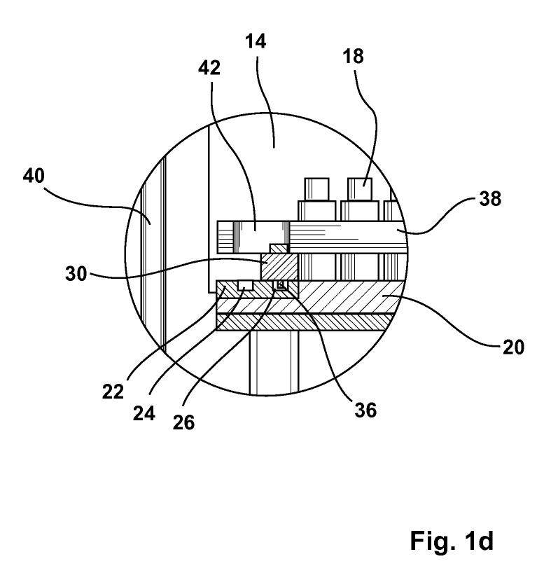

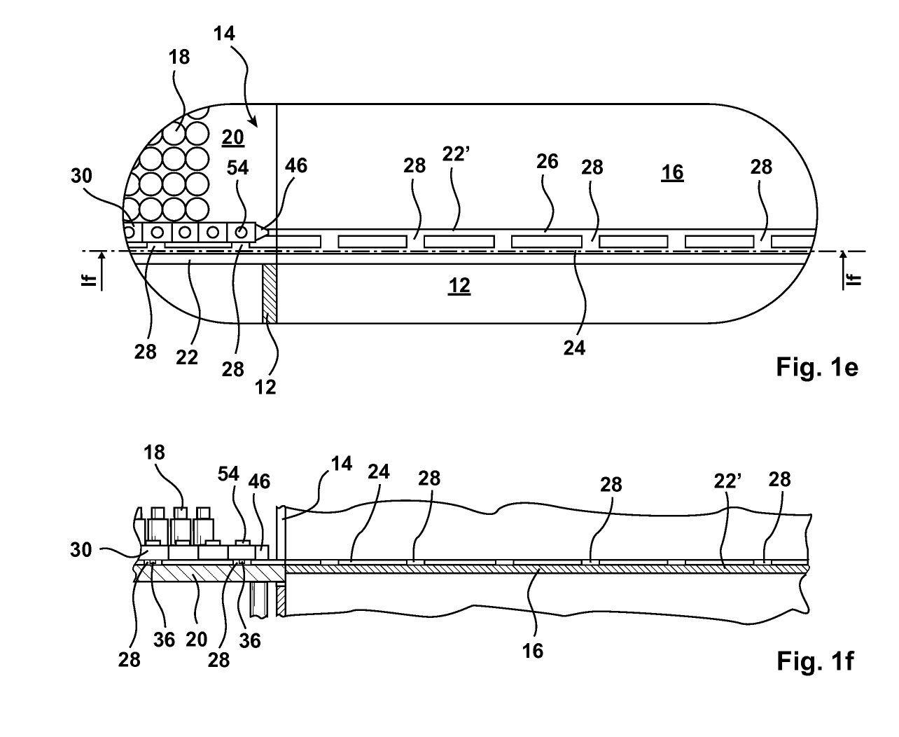

The FIGS. 1a through 1f show, in a schematic illustration, an apparatus of the disclosure for loading and unloading a tray of a freeze drying plant and such a freeze drying plant 10. This freeze drying plant 10 includes a large chamber 12 that is provided on one side with an opening 14 for loading and unloading. This opening 14 can be closed with a door that has not been illustrated herein. Inside the chamber 12, there is provided a number of trays 16 that are adapted for vertical travel through a mechanism that has not been illustrated herein.

The apparatus for loading and unloading a tray and the freeze drying plant associated therewith illustrated in the drawing are illustrated merely schematically. Many details have been omitted in order to allow for increased clarity in illustrating the basic principle of the apparatus and of the freeze drying plant.

The product to be dried is usually filled into small bottles referred to as vials 18, said vials 18 being provided with a lid which is open before the freeze drying process, said lid being closed after the freeze drying process in order not to soil the freeze dried product. Such an apparatus for loading and unloading a tray of a freeze drying plant and the freeze drying plant itself are usually placed in clean rooms for the drugs contained in the vials not to be contaminated. This however also means that the entire loading and unloading process must be completely automated.

The apparatus for loading and unloading a tray 16 of a freeze drying plant 10 with a number of vials 18 includes a transfer table 20 on which the vials 18, which usually arrive one by one or in rows, are collected until a sufficient number of vials 18 is available on the transfer table 20. The transfer table 20 is thereby configured to be a planar, level surface and is limited on the right and on the left side by a respective guide element 22. In the embodiment shown herein, the guide element 22 is directly connected to the transfer table 20, the upper side of the guide element 22 being flush with the top side of the transfer table 20. In the guide element 22, an outer groove 24 is provided on the outer edge, said groove extending over the entire length of the guide element 22. Directly next to the outer groove 24 there is provided an inner groove 26, which is offset slightly inward parallel to the outer groove 24 and which also extends over the entire length of the guide element 22.

As can be inferred in particular from FIG. 1b, each of the trays 16 comprises on its right and left edge a corresponding guide element 22′, each of them also respectively having an outer groove 24 and an inner groove 26. For loading the tray 16, said tray is caused to travel into the region of the opening 14 by means of the hoist mechanics that has not been illustrated herein so that the guide element 22 and the guide element 22′ abut flush with each other. As a result, the outer groove 24 and the inner groove 26 of the guide element 22 directly merges into the outer groove 24 and the inner groove 26 of the guide element 22′, as can be seen best from FIG. 1d.

Between the outer groove 24 and the inner groove 26 there are provided at certain intervals connecting grooves 28 which connect the outer groove 24 and the inner groove 26. The connecting grooves 28 are many times longer than the diameter of the guiding pin 36.

On each of the guide elements 22, which are arranged flush with the transfer table 20, there is disposed one transport carriage configured to be a pusher chain 30. This pusher chain 30 is stored on a cylinder 32 that causes it to move. The direction of rotation of the cylinder 32 determines the direction in which the pusher chain 30 moves. The cylinder 32 guides the pusher chain 30 about a deflection pulley 34 to the guide element 22 on the transfer table 20. The pusher chain 30 itself is composed of a number of individual links that are movable with respect to each other and which has certain stiffness while it pushes so that it can be utilized similar to a rod. At the underside of the pusher chain 30, there are disposed at regular intervals guiding pins 36, as can be seen best from FIG. 1f. At the time period shown in the FIGS. 1a through 1f, the guiding pins 32 of the pusher chain 30 engage the inner groove 26 of the guide element 22, thus reliably guiding the pusher chain 30 on the edge of the transfer table 20 or of the tray 16. It is understood that the guiding pins 36 are adapted to the size of the inner groove 26 or of the outer groove 24. As explained in closer detail herein after, the pusher chain 30 with its guiding pins 36 can also be guided in the outer groove 24.

In addition to the right and left pusher chain 30, the pusher device also has a loading element configured to be a loading pusher 38 that can be stowed in a shelf 40 located above the transfer table 20 when not needed. In this case, the loading pusher 38 is placed so far at the top on the shelf 40 for the vials 18 to be capable of passing underneath the loading pusher 38. The shelf 40 is provided with a corresponding automated mechanics and can place the loading pusher 38 onto the right and the left pusher chain 30 from where it can be retrieved in due time. On the right and on the left side of the loading pusher 38, long holes 42 engage into corresponding pins 54 on one of the links of the pusher chain 30 for the loading pusher 38 to be thus reliably retained on the right and left pusher chain 30. If now the right and the left pusher chain 30 are moved towards the tray 16, the loading pusher 38 is entrained, thereby pushing the vials 18 located on the transfer table 20 in front of it until they arrive on the tray 16.

As can be seen in particular from the FIGS. 1b and 1c, the right and the left pusher chain 30 is disposed on the transfer table 20, meaning on the guide element 22 for the pusher chains 30 forming a lateral limitation of the transfer table 20. The vials 18 are placed so close on the transfer table 20 that the vials 18 placed on the border can hit the corresponding pusher chain 30. This applies in an analogous fashion for the tray 16.

The apparatus for loading and unloading a tray also has two centering apparatus 44 that are mounted to a wall of the chamber 12 of the freeze drying plant 10 that is opposite the opening 14. Each of these centering apparatus 44 are positioned so as to be capable of receiving a head 46 of the pusher chain 30 as soon as said chain has passed the rear edge of the tray 16. The centering apparatus 44 is displaceable horizontally in order to transfer the pusher chain 30 from the inner groove 26 into the outer groove 24 and vice versa. Details thereof will be described in detail herein after with respect to the loading method.

In order to prevent the head 46 of the pusher chain 30 from falling down when said head 46 projects beyond the rear edge of the tray 16, a supporting table 47 is provided there. As a result, the head 46 always finds the way into the centering apparatus 44.

The apparatus for loading and unloading a tray 16 of a freeze drying plant 10 also possesses a retaining mechanism 48 for receiving an unloading pusher 50. Just like the centering apparatus 44, the retaining mechanism 48 is also mounted to the wall of the chamber 12 of the freeze drying plant 10 that is opposite the opening 14. It is understood that both the centering apparatus 44 and the retaining mechanism 48 are mounted to the chamber 12 together with the unloading pusher 50 so as not to hinder the vertical motion of the trays 16. The retaining mechanism 48 carries the unloading pusher 50 if it is not needed for unloading the trays 16. On the other side, the retaining mechanism 48 is capable of settling in the unloading pusher 50 onto the pusher chains 30 deployed as far as behind the rear edge of the tray 16 in such a manner that long holes 52 of the unloading pusher 50 located on the right and left edge engage into mating pins 54 provided on the pusher chain 30 for the right and the left pusher chain 30 to be capable of entraining the unloading pusher 50.

The method for loading and unloading the tray 16 of the freeze drying plant 20 with a number of vials 18 will be described in detail herein after:

To load a tray 16 of the freeze drying plant 10, the uppermost tray 16 of the stack located on the bottom of the chamber 20 is moved upward with a mechanics that has not been illustrated herein so that the tray 16 is flush with the transfer table 20. It is understood that the door of the freeze drying plant 10 has been opened before. A supplying device 56, which has been merely outlined herein, supplies the vials 18, which are collected on the transfer table 20. These vials 18 are thereby placed in rows, one row of vials 18 extending from a right pusher chain 30 to a left pusher chain 30. The spacings are thereby dimensioned for the desired number of vials 18 to register between the pusher chains 30. The pusher chains 30 are thereby deployed so far that their front head lies in front of the first row of vials 18 on the transfer table 20. As soon as all the vials 18 have been gathered on the transfer table, the shelf 40 lowers the loading pusher 38 from its raised position onto the right and onto the left pusher chain 30, the long holes 42 of the loading pusher 38 receiving a pin 54 mounted on the top side of the pusher chain 30.

Next, the cylinder 32 is put into operation and drives the right and the left pusher chain 30 together with the loading pusher 38 forward for the vials 18 to be pushed from the transfer table 20 to the tray 16. The vials 18, the right and the left pusher chain 30 and the loading pusher 38 are forced to move at the same speed so that no friction occurs between the vials 18 disposed on the border and the pusher chains 30. As a result, no friction occurs between the vials 18 and the pusher chain while the tray 16 is being loaded so that no vial 18 can tip over. Another advantage is that through this orderly displacement of the vials 18 the sequence and order of the vials 18 on the transfer table 20 is maintained.

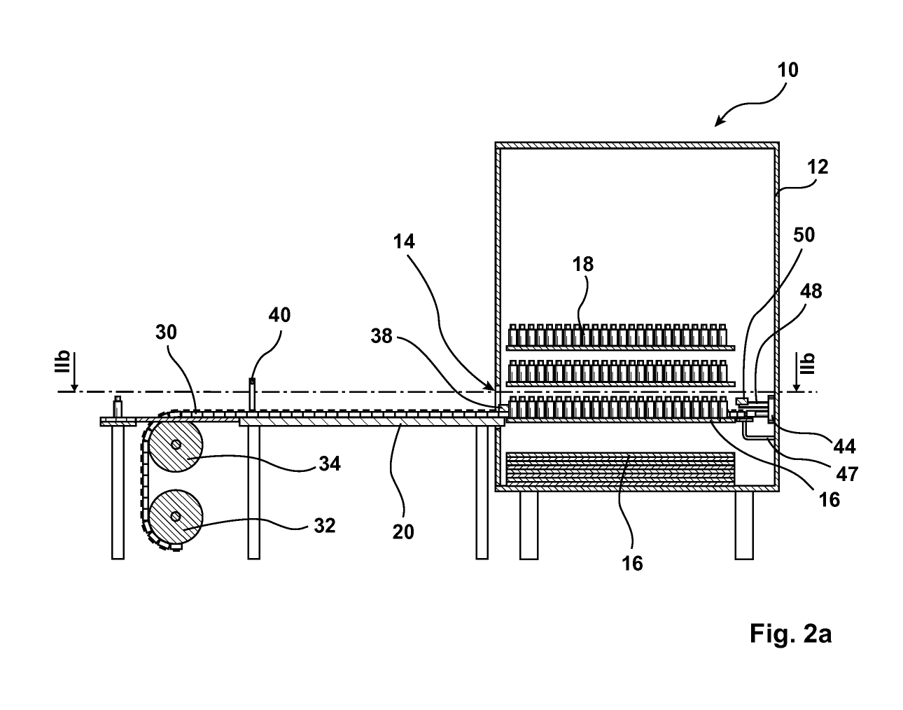

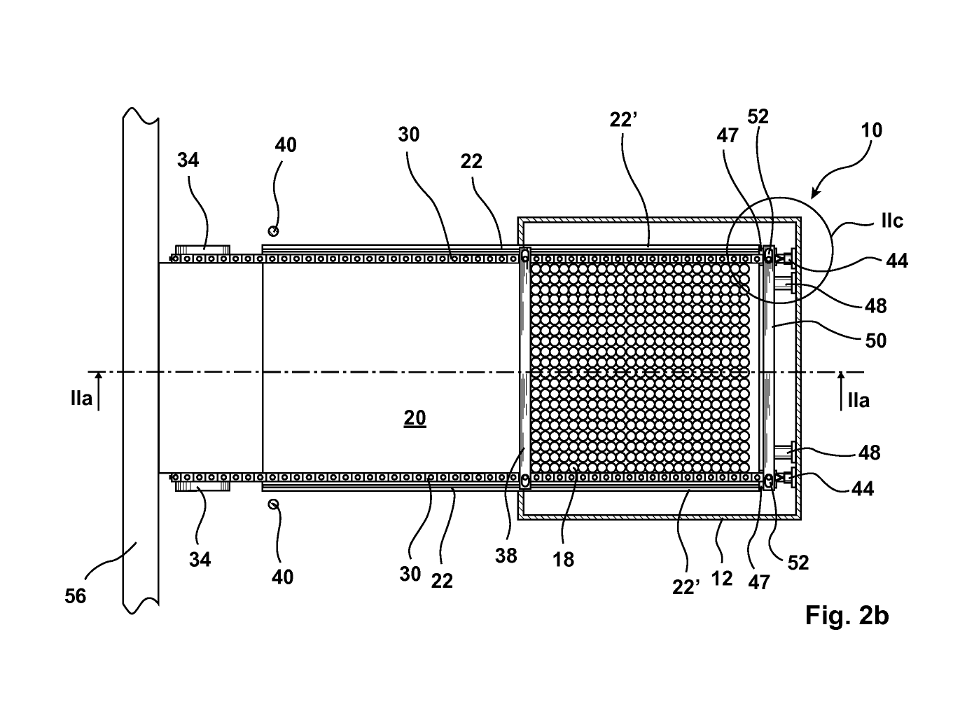

In the FIGS. 1a through 1f, the apparatus of the disclosure and the freeze drying plant 10 is illustrated at a first time period, shortly before the vials 18 are displaced from the transfer table 20 onto the trays. In the FIGS. 2a through 2c, there is illustrated a second time period at which the vials 18 have completely arrived on the tray 16 and at which the pusher chains 30 are in their completely extended end position.

As can be seen in FIG. 2c in particular, the head 46 of the pusher chain 30 is taken hold of by the centering apparatus 44 as soon as the pusher chain 30 has reached its end position, the head 46 resting on the supporting table 47. The centering apparatus 44 thereby also fixes the head 46 of the pusher chain 30 and pushes the head 46, and as a result thereof at least one part of the pusher chain 30, from the inner groove 26 onto the outer groove 24. At the same time, the deflection pulley 34 at the other end of the pusher chain 30 is also offset outward for this part of the pusher chain 30 to be also transferred from the inner groove 26 onto the outer groove 24. Now, large portions of the pusher chain 30 are in the outer groove 24, whilst in the center area of the pusher chain 30 parts may still lie on the inner groove 26 or in the connecting webs 28. As soon however as the pusher chain drive pulls the pusher chain 30 tight, all of the remaining parts of the pusher chain 30 are pulled into the outer groove 24.

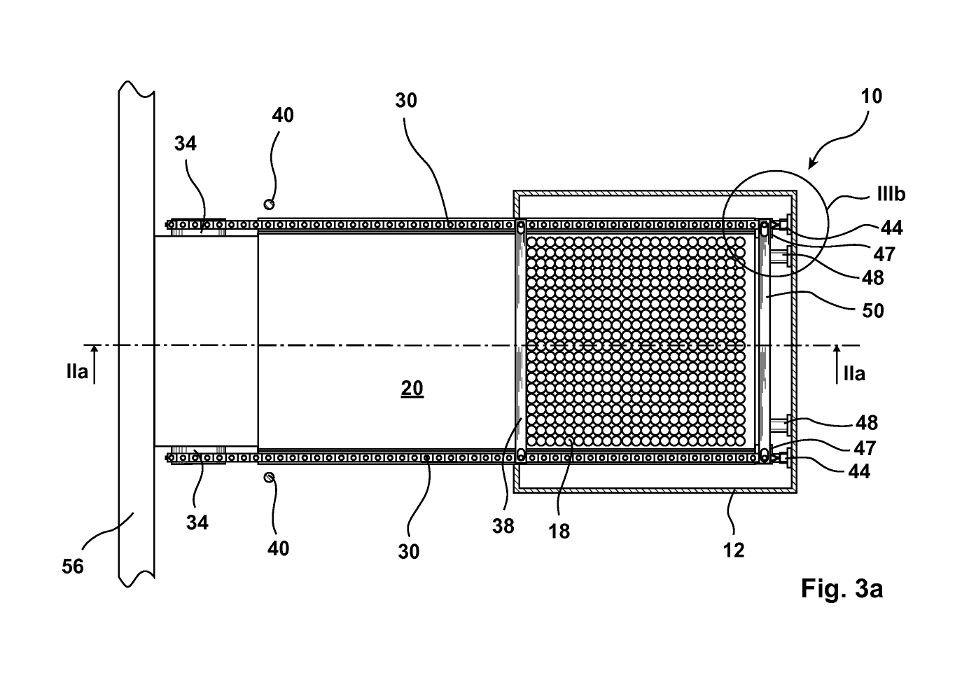

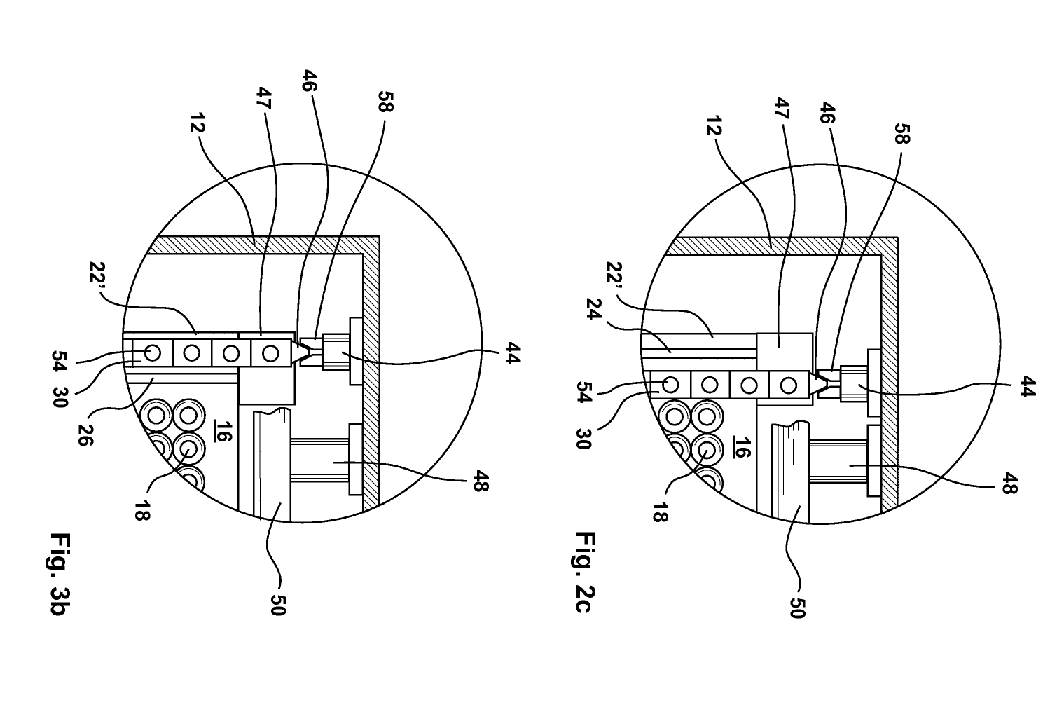

As can be seen from FIG. 3b in particular, the pusher chain 30 is now guided in the outer groove 24 and is spaced a significant distance from the vials 18. In the FIGS. 3 and 3b, this third time period is shown.

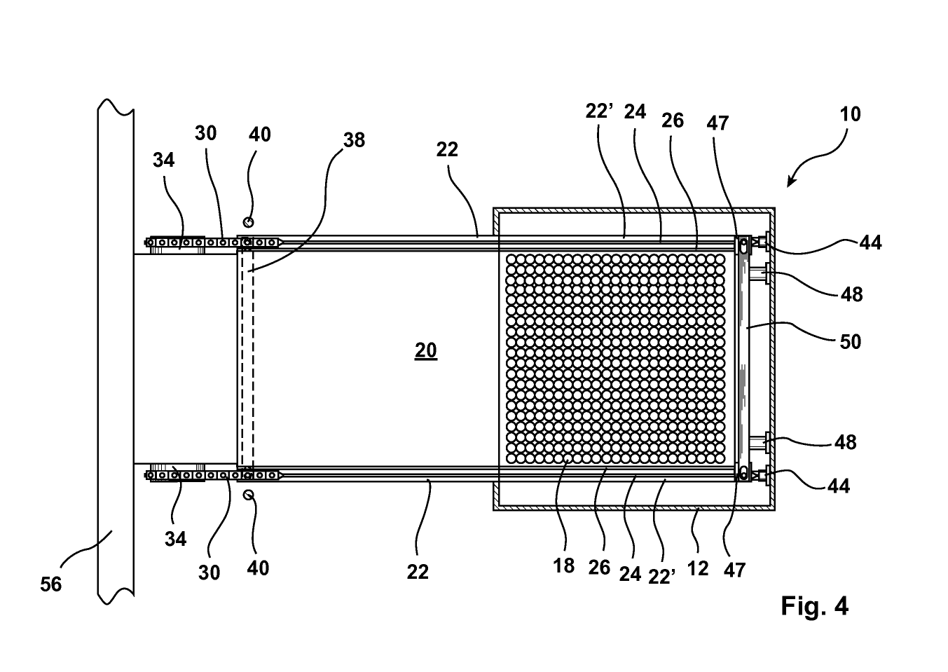

Then, the two pusher chains 30 are pulled out of the freeze drying plant 10 together with the loading pusher 38, said pusher chain 30 winding onto the cylinder 32 as is best seen from FIG. 4. Arrived at the shelf 40, the loading pusher 38 is taken hold of by the shelf 40 and raised.

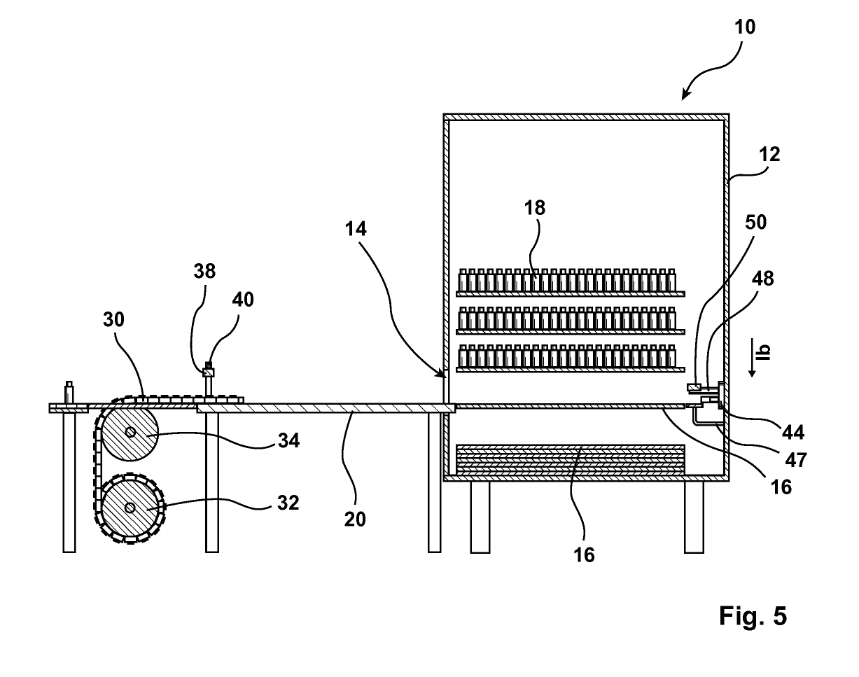

As soon as the pusher chain 30 is wound as far as possible on the cylinder 32, the deflection pulleys 34, which are not shown in closer detail in FIG. 4, are moved inward for the pusher chain 30 to be transferred from the outer groove 24 into the inner groove 26. It is understood that, upon transfer of the pusher chain 30 from the outer groove 24 into the inner groove 26, the guiding pins 36 disposed underneath the pusher chain 30 are guided via the connecting grooves 28, as this is best illustrated in the FIGS. 1e and 1f. Associated therewith, the fully loaded tray 16 is moved further upward inside the chamber 12 together with the trays 16 loaded before and the next tray 16 is taken from the stack and brought to the transfer table 20, as it is shown in FIG. 5 at a fifth time period. Now, the loading process can begin again.

As soon as all the trays 16 are loaded, the transfer table 20 is removed from the freeze drying plant 10 and the door of the freeze drying plant, which has not been illustrated herein, is closed for the actual freeze drying process to take place.

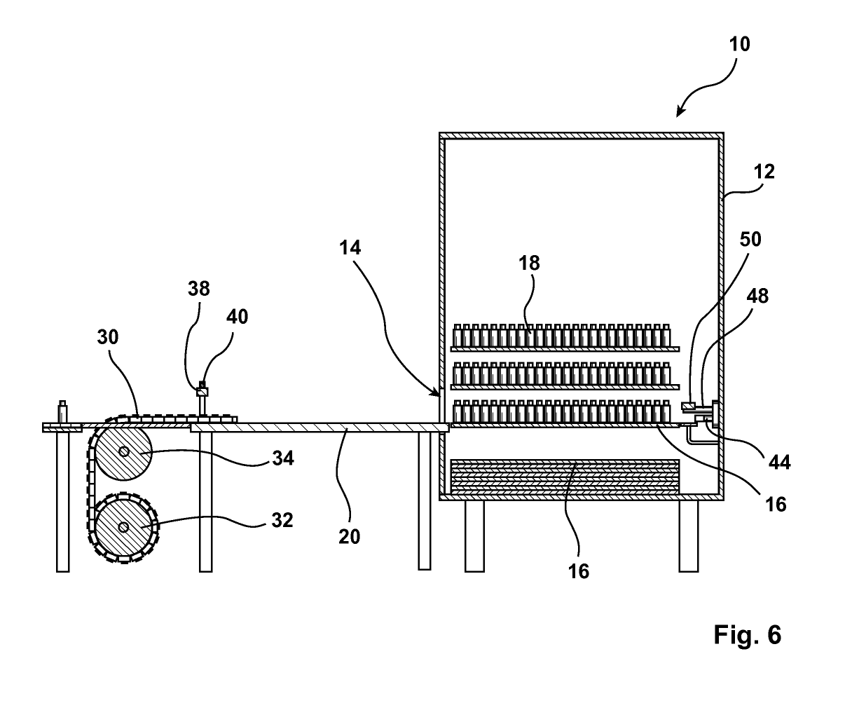

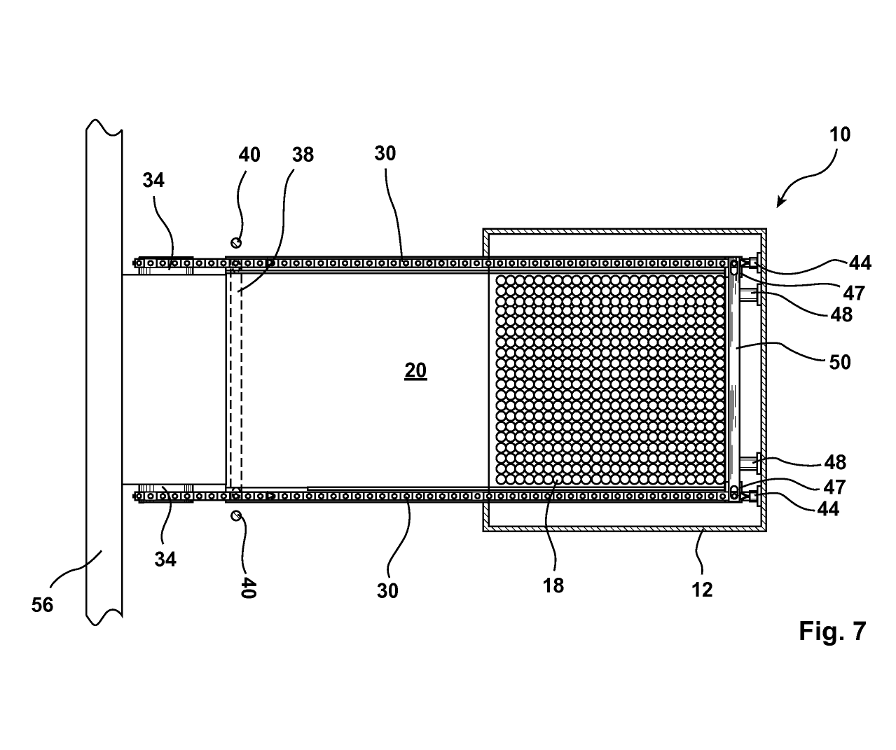

Upon completion of the freeze drying process, the trays 16 are caused to travel vertically downward simultaneously or consecutively for the tray to abut the vials located underneath, thus pushing the lid located in the vials downward and closing them. Next, the trays 16 are again spaced slightly apart so as to allow for unloading the trays. Now, the door of the freeze drying plant 10 is opened again and the transfer table 20 is moved to the opening 14 in order to unload the first tray 16. At the sixth time period shown in FIG. 6, some trays 16 have already been unloaded and stacked on the bottom of the chamber 12. Another tray 16 is moved flush with the transfer table 20 and ready for unloading. For this purpose, the two pusher chains 30 are now moved into the freeze drying chamber 12 in the respective outer groove 24 on the guide elements 22 and 22′ without the loading pusher 30 until the head 46 of the pusher chain 30 reaches the centering apparatus 44 for the tongs 58 to fix the head 46 of the pusher chain 30, as this is shown in FIG. 7 at the seventh time period.

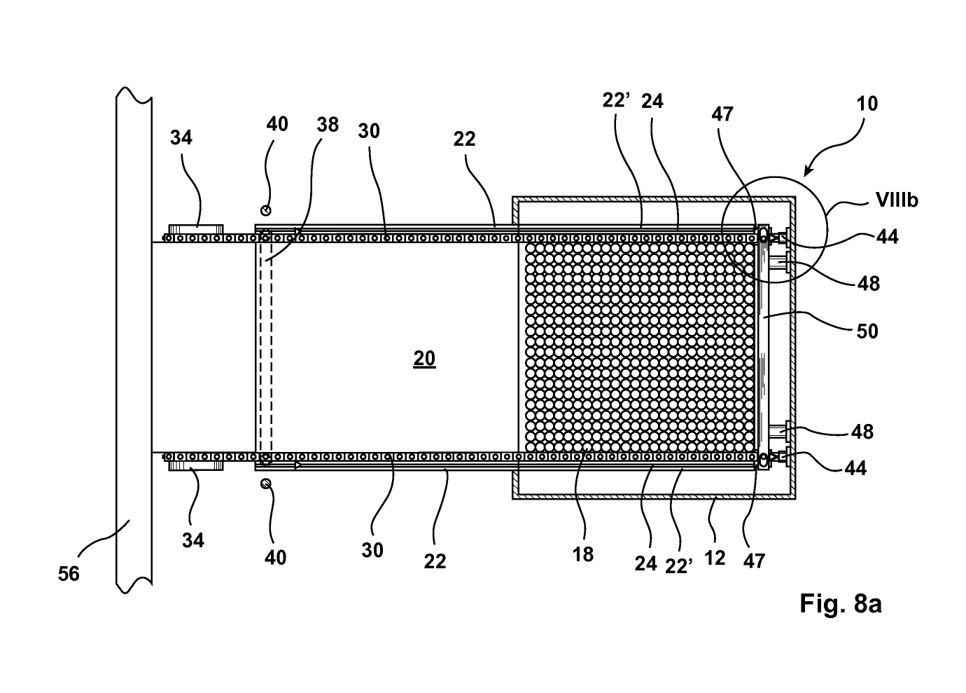

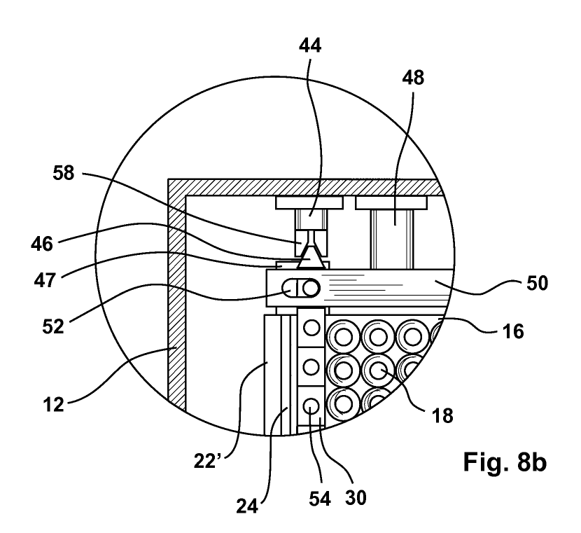

Next, the deflection pulley 34 and the centering apparatus 44 are caused to move in the opposite direction for the pusher chains 30 to be displaced from the outer groove 24 into the inner groove 26 as shown in the FIGS. 8a and 8b at the eighth time period.

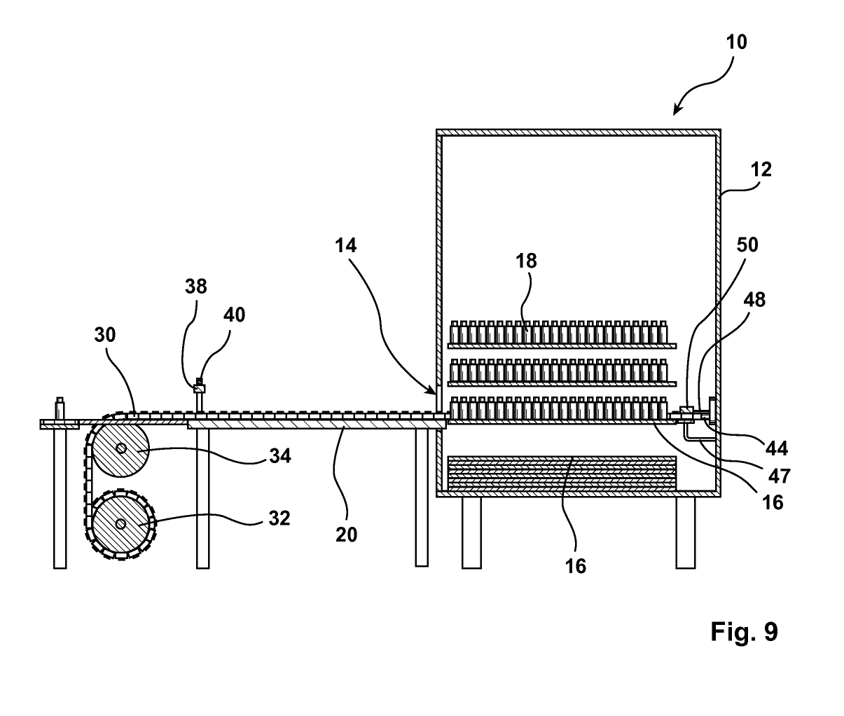

Next, the retaining mechanics 48 places the unloading pusher onto a foremost link of the pusher chain 30 for the pin 54 to engage the long hole 52 of the unloading pusher 50, thus retaining it. This ninth time period is shown in FIG. 9.

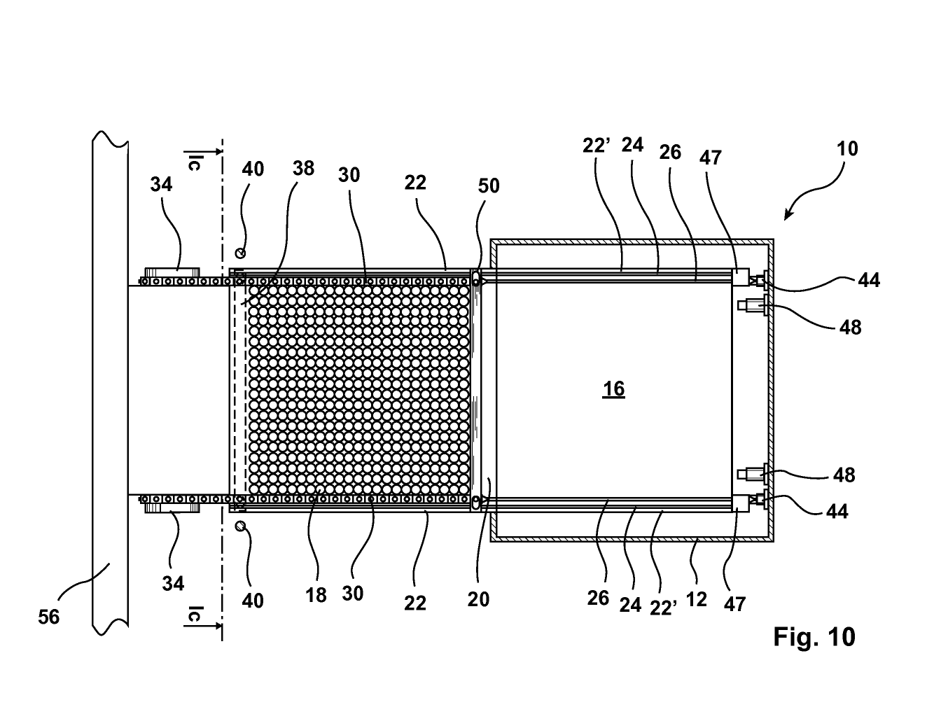

Next, the cylinder 32 pulls the pusher chains 30 together with the unloading pusher 50 out of the chamber 12, the pusher chains 30 winding again on the cylinder 32. As soon as all the vials 18 have arrived on the transfer table 20, as is shown in FIG. 10 at the tenth time period, the vials 18 are evacuated for further processing through an evacuation device 56 that has not been illustrated herein. Since no relative movement takes place between the vials 18 and the pusher chain 30 when the vials 18 are being removed from the freeze drying plant 10, the vials 18 keep their positions relative to the other vials 18. As a result, it is possible to conclude the quality of the freeze drying process via a quality control of the products contained in the vials. Also, through this known position of the discrete vials 18, it is possible to remove from the plant at a later stage those vials 18 that were located on critical points on the tray 16. As a result, the quality control of the freeze drying process is facilitated since only the known, critical vials 18 need to be subjected to quality control in order to allow for detecting the quality of the freeze drying process.

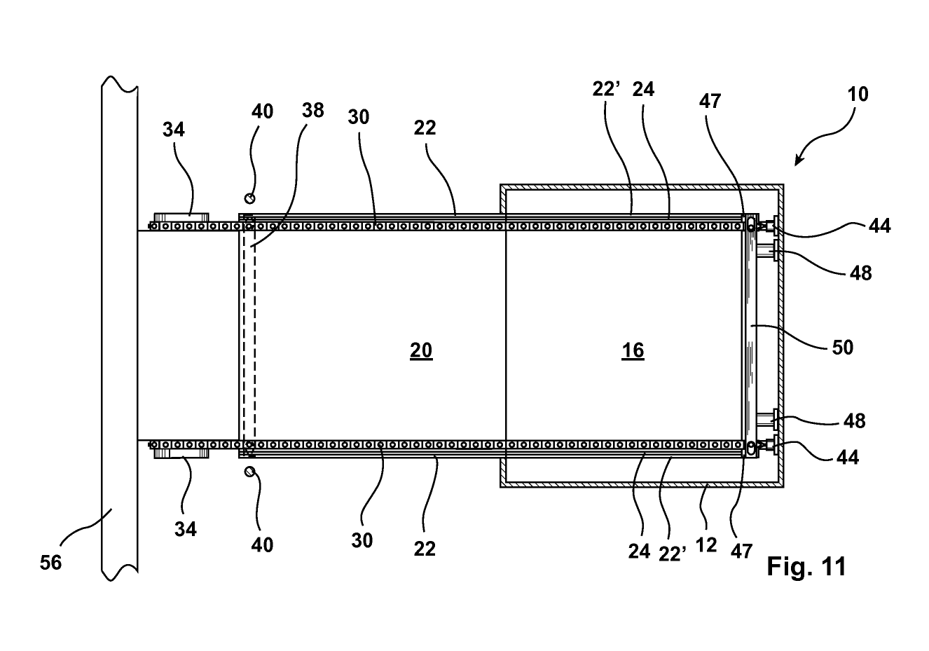

Once all the vials have been evacuated, the pusher chains 30 are again moved together with the unloading pusher 50 as far as the rear wall of the chamber 12 for the retaining mechanism 48 to be capable of receiving again the unloading pusher 50 as this can be seen at the eleventh time period shown in FIG. 11. Next, the centering apparatus 44 again take hold of the heads 46 of the pusher chains 30 and transfer pusher chains 30 in the way described before from the inner groove 26 into the outer groove 24 before the pusher chains 30 are again pulled out of the freeze drying plant by the cylinder 32. Now, the tray 16, which has been emptied in the meantime, is placed onto the stack on the bottom of the chamber 12 and the next tray 16 is moved to the transfer table 20 to be emptied before the next tray 16 is emptied in the way described. This process is repeated until all of the trays 16 are empty.

The advantage of mounting the unloading pusher 50 to the rear wall of the chamber 12 is that the unloading pusher needs not be passed over the freshly closed vials 18 in order to remove the vials 18 from the tray 16. As a result, the vertical spacing between neighbouring trays 16 can be reduced so that, although the chamber keeps the same size, additional trays can be integrated, this in turn increasing the economic efficiency of the freeze drying plant.

Another advantage is that the vials, which sometimes adhere to the upper tray, can no longer be detached by the incoming unloading pusher and overturn. With the unloading pusher disposed behind the trays, one achieves that the vials adhering to the upper trays are only detached if the entire field of the vials is moved toward the output. In this case, the vial falling down from the top is guided by the neighbouring vials so that this vial cannot fall down. This is also promoted by the fact that the free space between the upper edge of the vials and the underside of the next tray is smaller. In other words, the vial cannot fall so low when it detaches from the upper tray so that the probability for the vial to tilt over is reduced to a minimum.

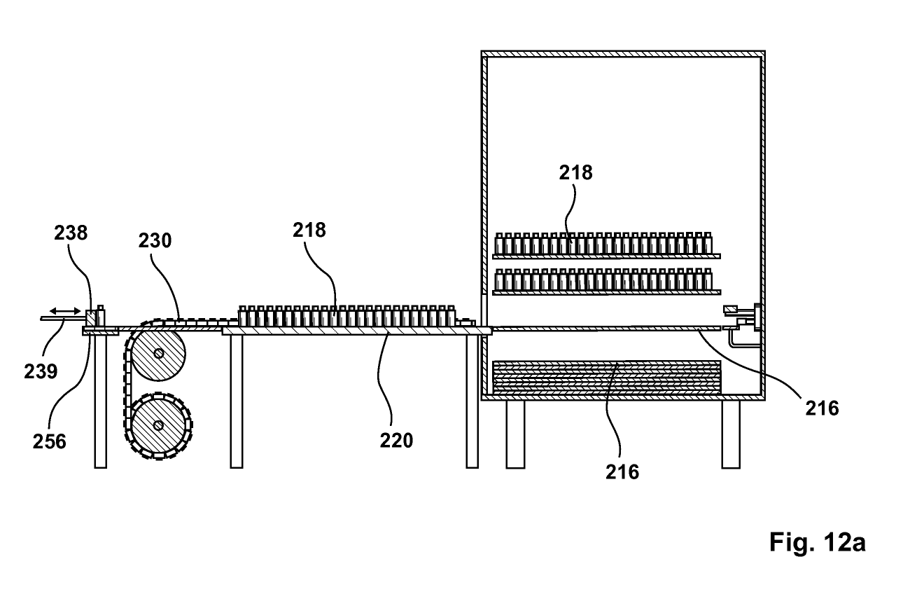

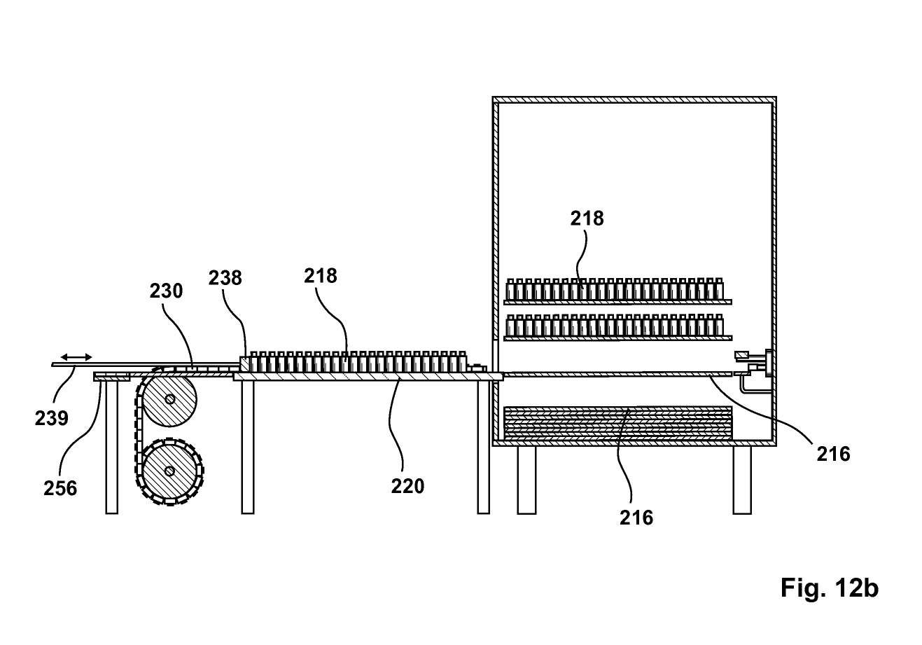

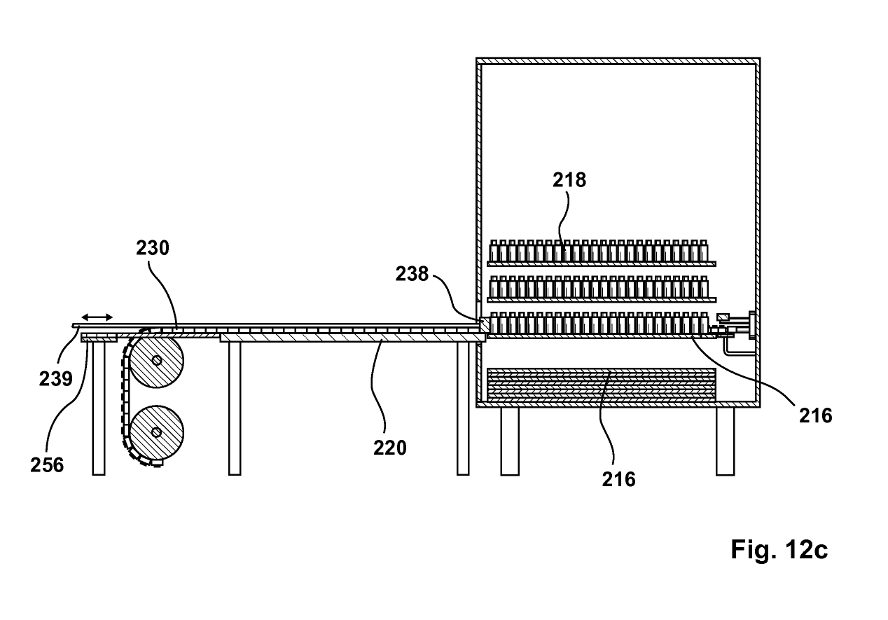

The FIGS. 12a through 12c schematically show a second embodiment of an apparatus of the disclosure. This second embodiment only differs from the first embodiment shown in the FIGS. 1a through 1f by the fact that a pusher 238 is utilized for pushing the vials 218 instead of the loading pusher. This pusher 238 is caused to move by a separate apparatus that has not been illustrated herein, said apparatus being connected to the actual pusher 238 through a connecting rod 239. This pusher extends over the entire width of the transfer table 220, meaning from the left pusher chain 230 to the right pusher chain 230. As can be seen from FIG. 12a in particular, the vials 218 are delivered through the feeding device 256. From there, the vials 218 are pushed by the pusher 238 onto the transfer table 220. As soon as enough vials 218 have gathered on the transfer table, the pusher 238 acts onto the foremost vials 218 and pushes all of the vials 218 located on the transfer table 220 onto the tray 216, as can be seen from the FIGS. 12b and 12c. The pusher chains 230 are thereby driven forward at the same speed as the pusher 238 for no friction to occur between the pusher chains 230 and the vials 218 abutting thereon so that no vials 218 will tip over and for the vials 218 to arrive on the tray 216 in the given classification. For the rest, this second embodiment is identical with the first embodiment shown in the FIGS. 1a through 1f and described herein above.

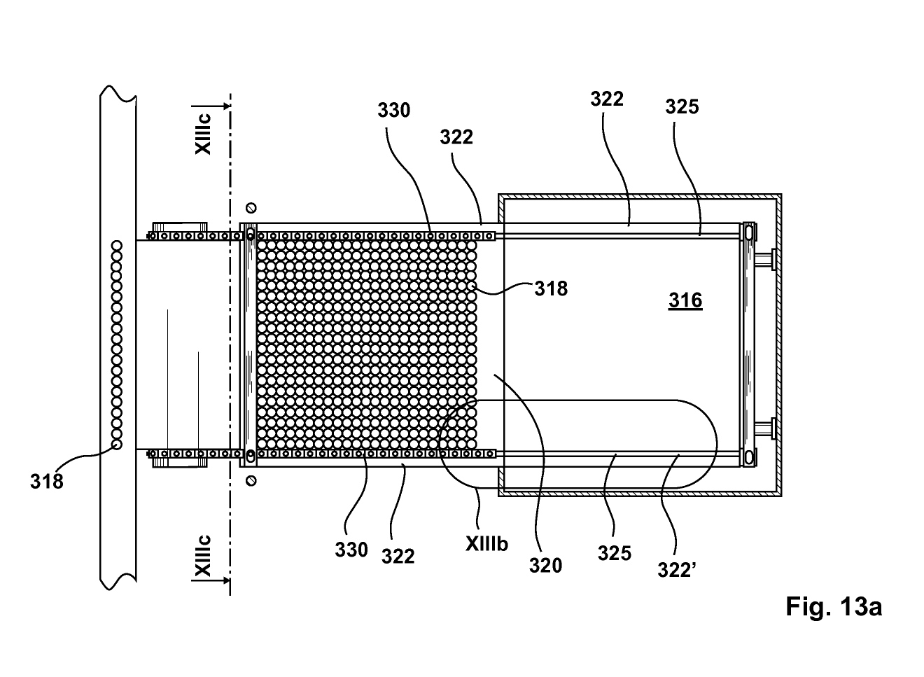

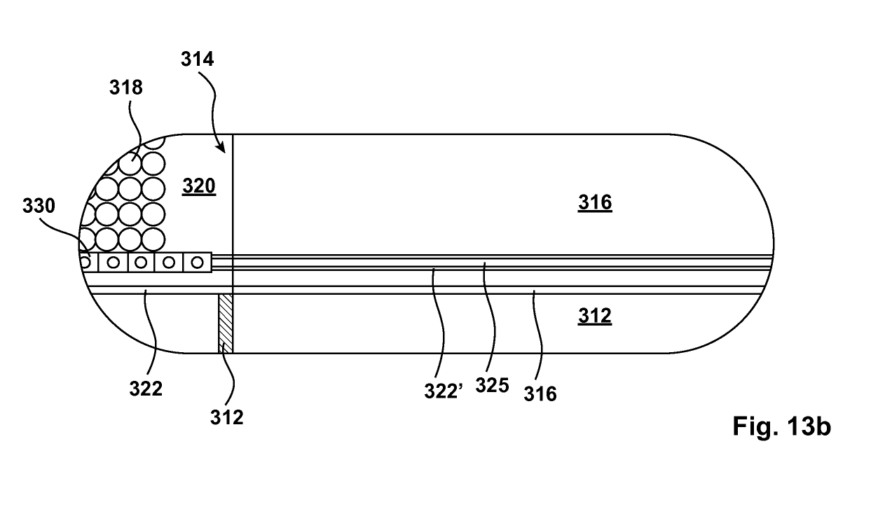

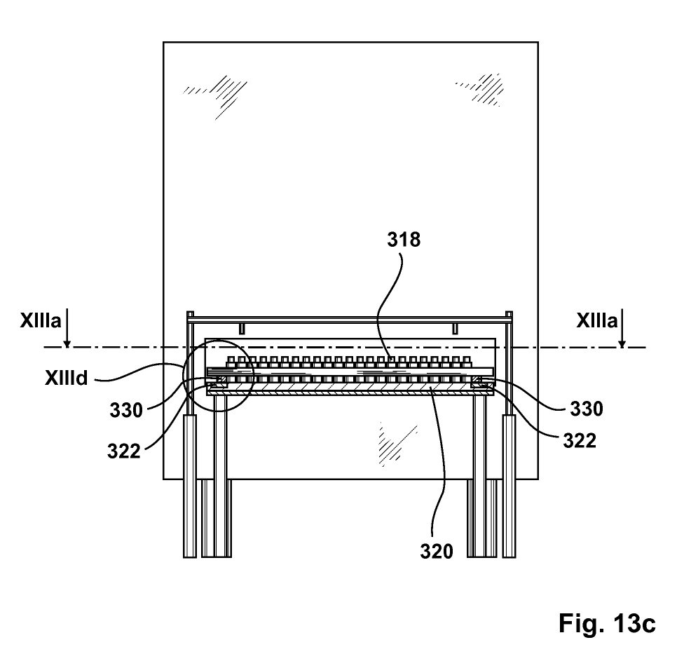

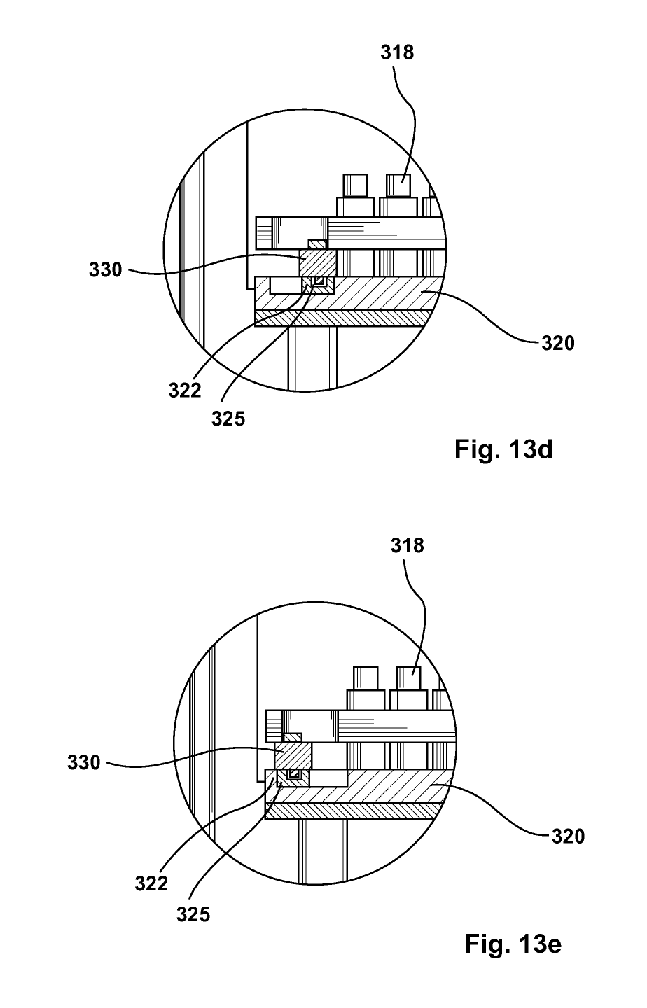

In the FIGS. 13a through 13e, there is schematically illustrated a third embodiment of an apparatus of the disclosure. This third embodiment differs from the first embodiment shown in the FIGS. 1a through 1f by the mere fact that the guide element 322 retained on the transfer table 320 and the guide element 322′ retained on the tray 316 only comprises one single guiding groove 325 and that no centering apparatus is provided. Instead, the guiding elements 322 and 322′ are retained for lateral displacement on the transfer table 320 and on the tray 316, said guiding elements 322 and 322′ being displaceable towards the right and towards the left by 1 mm through 30 mm, preferably by 15 mm, so that the transport carriage, which is configured to be a pusher chain 330, can be spaced apart from the vials 318 at need. This preferably occurs whenever the pusher chain 330 has to make an empty run in order for it to get spaced from the vials 318 normally abutting the pusher chain 330 so that these vials 318 will not inadvertently tip over or become displaced from their original position. The laterally slidable guiding elements 322 and 322′ are thereby operated by a pneumatic control. For the rest, this third embodiment is identical with the first embodiment illustrated in the FIGS. 1a through 1f and described herein above.

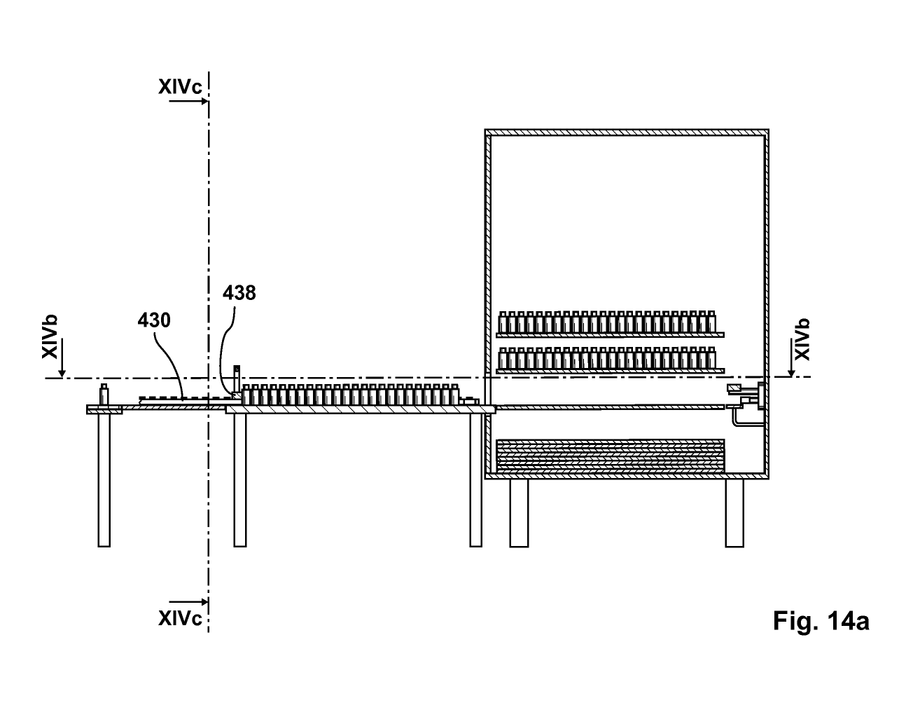

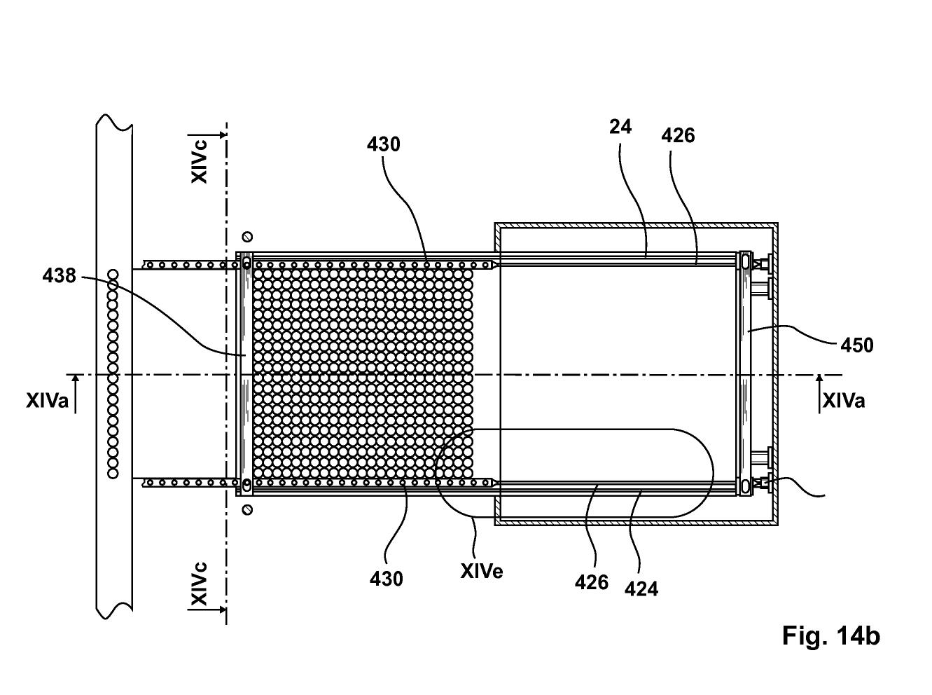

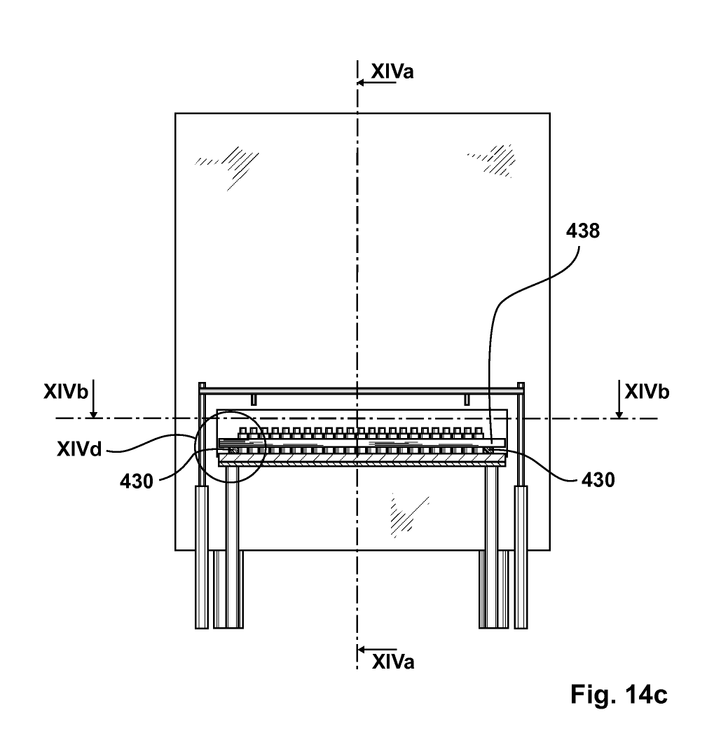

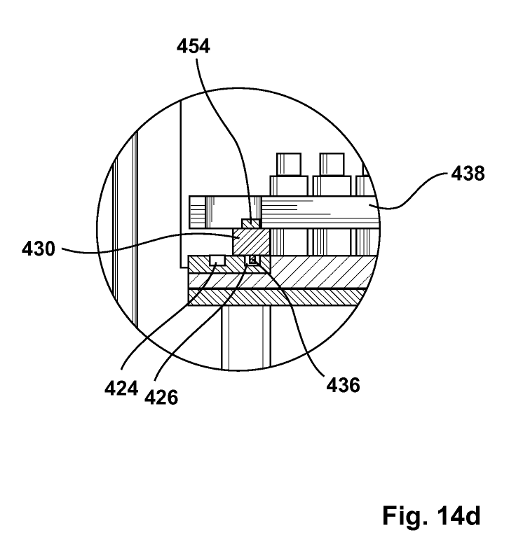

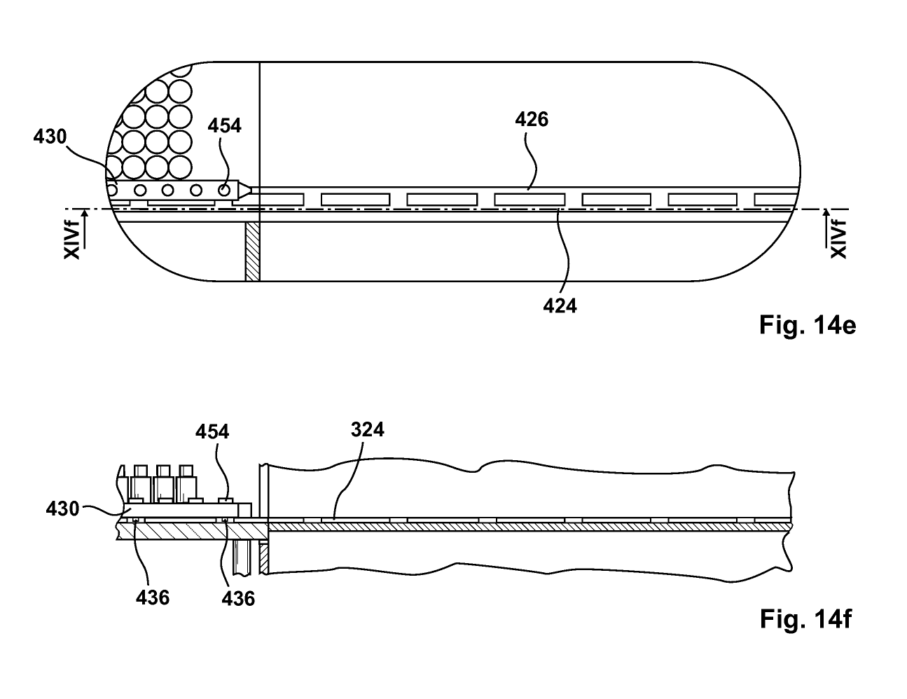

In the FIGS. 14a through 14f, there is schematically shown a fourth embodiment of an apparatus of the disclosure. This fourth embodiment merely differs from the first embodiment shown in the FIGS. 1a through 1f by the fact that a rod 430 is utilized instead of the pusher chain. Like the pusher chain, this rod 430 is guided in the inner groove 426 or in the outer groove 424 via guiding pins 436 and has on its upper side pins 454 for receiving the loading pusher 438 and the unloading pusher 450. For the rest, this fourth embodiment is identical with the first embodiment illustrated in the FIGS. 1a through 1f and described herein above.

### List of Numerals

| | |
|---|---|
| 10 | Freeze drying plant |
| 12 | Chamber |
| 14 | Opening |
| 16, 216, 316, | Tray |
| 18, 218, 318, | Vial |
| 20, 220, 320 | Transfer table |
| 22, 322 | Guiding element |
| 22′, 322′ | Guiding element |
| 24, 424 | Outer groove |
| 26, 426 | Inner groove |
| 28 | Connecting groove |
| 30, 230, 330 | Pusher chain |
| 430 | Rod |
| 32 | Cylinder |
| 34 | Deflection pulley |
| 36, 436 | Guiding pin |
| 38, 438 | Loading pusher |
| 238 | Pusher |
| 40 | Shelf |
| 42 | Long hole |
| 44 | Centering apparatus |
| 45 | Supporting table |
| 46 | Head |
| 48 | Retaining mechanism |
| 50, 450 | Unloading pusher |
| 52 | Long hole |
| 54, 454 | Pin |
| 56 | Feeding device |
| 58 | Tongs |

We claim:

1. An apparatus for loading and unloading a tray (16, 216, 316) of a freeze drying plant (10) with a number of vials (18, 218, 318), with a transfer table (20, 220, 320) provided upstream of the freeze drying plant (10) for receiving temporarily said vials (18, 218, 318), and with a pusher apparatus for displacing said vials (18, 218, 318) from said transfer table (20, 220, 320) to said tray (16, 216, 316) or from said tray (16, 216, 316) to said transfer table (20, 220, 320), said pusher apparatus including a right-handed and a left-handed transport carriage (30, 230, 330, 430),
characterized in that said pusher apparatus further includes a loading element (38, 438) and an unloading pusher (50, 450), said loading element (38, 438) being disposed outside of the freeze drying plant (10) whilst the unloading pusher (50, 450) is arranged inside the freeze drying plant (10).

2. The apparatus as set forth in claim 1,
characterized in that the unloading pusher (50, 450) is retained at a side of the chamber (12) that is opposite the opening (14) of the freeze drying plant (10).

3. The apparatus as set forth in claim 1,
characterized in that the transport carriage (30, 230, 330, 430) is displaceable transverse to its travel direction.

4. The apparatus as set forth in claim 1,
characterized in that the unloading pusher (50, 450) can be placed onto the transport carriages (30, 230, 330, 430) to unload the tray (16, 216, 316).

5. The apparatus as set forth in claim 4,
characterized in that the unloading pusher (50, 450) is retained on a retaining mechanism (48) that is mounted to the freeze drying plant (10) and by means of which the unloading pusher (50, 450) can be placed onto the transport carriages (30, 230, 330, 430) and removed therefrom again.

6. The apparatus as set forth in claim 4,
characterized in that the unloading pusher (50, 450) comprises one long hole (52) at either end.

7. The apparatus as set forth in claim 1,
characterized in that the loading element is configured to be a pusher (238).

8. The apparatus as set forth in claim 1,
characterized in that the loading element is configured to be a loading pusher (38, 438).

9. The apparatus as set forth in claim 8,
characterized in that the loading pusher (38, 438) can be placed onto the transport carriages (30, 330, 430) for loading the tray (16, 316).

10. The apparatus as set forth in claim 9,
characterized in that the loading pusher (38, 438) is retained on a shelf (40) which is mounted in the region of the transfer table (20, 320) and by means of which the loading pusher (38, 438) can be placed onto the transport carriages (30, 330, 430) and removed therefrom again.

11. The apparatus as set forth in 8,
characterized in that the loading pusher (38, 438) comprises one long hole (42) at either end.

12. The apparatus as set forth in claim 1,
characterized in that the transport carriage is configured to be a pusher chain (30, 230, 330).

13. The apparatus as set forth in claims 1,
characterized in that the transport carriage is configured to be a rod (430).

14. A method of loading or unloading a tray of a freeze drying plant with a number of vials,
characterized in that, for loading a tray (16, 216, 316), a loading pusher (38, 438) is placed onto a left and a right transport carriage (30, 230, 330, 430) in the region in front of the vials (18) and that the transport carriages (30, 230, 330, 430) are caused to move onto the tray (16, 216, 316) together with the loading pusher (38, 438) and the vials (18, 218, 318).

15. A method of loading or unloading a tray of a freeze drying plant with a number of vials,
characterized in that, for unloading a tray (16, 216, 316), a right and a left transport carriage (30, 230, 330, 430) are retracted so far into the freeze drying plant (10) for a part of the transport carriage (30, 230, 330, 430) to extend as far as behind the vials (18, 218, 318), that an unloading pusher (50, 450) is placed onto the transport carriages (30, 230, 330, 430) and that the transport carriages (30, 230, 330, 430) are then pulled from the tray (16, 216, 316) onto the transfer table (20, 220, 320) together with the unloading pusher (50, 450) and the vials (18, 218, 318).
